(19) United States
(12) Patent Application Publication
(10) Pub. No.: US 2026/0044747 A1
(43) Pub. Date: Feb. 12, 2026

(54) HYPERPARAMETER OPTIMIZATION USING PARTITIONED MACHINE LEARNING MODELS

(71) Applicant: QUALCOMM Incorporated, San Diego, CA (US)

(72) Inventors: Bruno Kacper MLODOZENIEC, Cambridge (GB); Christos LOUIZOS, Amsterdam (NL)

(21) Appl. No.: 19/102,570

(22) PCT Filed: Aug. 1, 2023
(86) PCT No.: PCT/US2023/071436

§ 371 Date: Feb. 10, 2025

(30) Foreign Application Priority Data
Sep. 28, 2022 (GR) 20220100793

(51) Int. Cl. G06N 3/0985

(52) U.S. Cl. CPC G06N 3/0985

(57) ABSTRACT

Certain aspects of the present disclosure provide techniques and apparatus for improved machine learning. A plurality of subnetworks, of a neural network is determined. Training of a first subnetwork of the plurality of subnetworks is facilitated using a first set of training exemplars from a plurality of sets of training exemplars, and training of a second subnetwork of the plurality of subnetworks is facilitated using a second set of training exemplars from the plurality of sets of training exemplars. A first loss is generated by processing the second set of training exemplars using the first subnetwork. An approximated marginal likelihood for the neural network is generated based at least in part on the first loss, and one or more hyperparameters of the neural network are refined based on the approximated marginal likelihood.

### CROSS-REFERENCE TO RELATED APPLICATION(S)

This application claims priority to Greece Patent Application Serial No. 20220100793, filed Sep. 28, 2022, which is hereby incorporated by reference herein.

### INTRODUCTION

Aspects of the present disclosure relate to machine learning.

Machine learning architectures have been used to provide solutions for a wide variety of computational problems. An assortment of machine learning model architectures exist, such as artificial neural networks (which may include convolutional neural networks (CNNs), recurrent neural networks (RNNs), deep neural networks, generative adversarial networks (GANs), and the like), random forest models, and the like. Many machine learning models rely on well-tuned hyperparameters during training (such as the weight decay, the learning rate, and the like) to perform well. In conventional systems, hyperparameters are often defined using iterative training, such as by selecting or defining a candidate set of hyperparameters manually, randomly, or automatically (e.g., using Bayesian optimization). A model can then be trained using the selected hyperparameters, and the model performance can be evaluated. A new set of hyperparameters are then defined for a fresh round of model training. Such conventional hyperparameter tuning processes are generally slow, demand substantial computational resources (e.g., to train the model multiple times), and often lead to suboptimal results.

Some approaches seek to enable hyperparameter optimization during training by using a validation set of data. However, these approaches generally rely on large validation sets (which are not always available). Further, model performance could generally have been improved by using the validation set itself for training, rather than for hyperparameter optimization. Accordingly, conventional solutions fail to provide optimal hyperparameter refinement and model accuracy.

### BRIEF SUMMARY

Certain aspects provide a method comprising: determining a plurality of subnetworks, of a neural network; facilitating training of a first subnetwork of the plurality of subnetworks using a first set of training exemplars from a plurality of sets of training exemplars; facilitating training of a second subnetwork of the plurality of subnetworks using a second set of training exemplars from the plurality of sets of training exemplars; generating an approximated marginal likelihood for the neural network based at least in part on a first loss generated by processing the second set of training exemplars using the first subnetwork; and refining one or more hyperparameters of the neural network based on the approximated marginal likelihood.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example workflow for hyperparameter optimization using partitioned machine learning models.

FIGS. 2A, 2B, and 2C depict example workflows to perform hyperparameter optimization using partitioned machine learning models.

FIG. 3 is a flow diagram depicting an example method for hyperparameter optimization using partitioned machine learning models.

FIG. 4 is a flow diagram depicting an example method for training machine learning model partitions for hyperparameter optimization.

FIG. 5 is a flow diagram depicting an example method for approximating marginal likelihood to enable improved hyperparameter optimization using partitioned machine learning models.

FIG. 6 is a flow diagram depicting an example method for parameter and hyperparameter optimization using federated learning.

FIG. 7 is a flow diagram depicting an example method for refining hyperparameters for partitioned machine learning models.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for improved machine learning hyperparameter optimization.

In some aspects, machine learning models can be partitioned or delineated into a set of model partitions, where each partition can be trained using a corresponding set of training data (e.g., a corresponding partition of a corpus of training data). As discussed in more detail below, this partitions of the model can then be used to efficiently determine or approximate the marginal likelihood of the model, which can be used to drive hyperparameter optimization.

In an aspect, the marginal likelihood can be used as an objective during training to enable active optimization of the hyperparameters using the training set itself (e.g., using the data that is used to train or refine the model parameters), without the use of a validation set or other data. Generally, marginal likelihood is robust to overfitting. However, in conventional approaches, determining the marginal likelihood of a model is intractable for a variety of common architectures, such as deep neural networks. For example, some approaches involve training many models in parallel in order to compute the marginal likelihood, which is often prohibitively expensive in terms of computational resources.

In aspects of the present disclosure, the marginal likelihood can be efficiently approximated using partitioned models and training, as discussed below in more detail. In an aspect, the marginal likelihood approximation is performed using differentiable techniques, enabling efficient gradient-based hyperparameter optimization. Further, in some aspects described herein, mini-batched estimates of marginal likelihood can be generated, bringing the varied benefits of stochastic gradient descent to hyperparameter optimization. Additionally, in some aspects, the techniques and systems disclosed herein are readily applicable to federated learning environments, and can further reduce communication overhead of such federated learning approaches, as discussed below in more detail.

Using aspects of the present disclosure, the machine learning model accuracy can be substantially improved (e.g., in terms of accuracy or test log-likelihood) and total training time can be maintained or reduced, as compared to conventional approaches. Additionally, learning invariances can improve performance in low-data regimes using some aspects of the present disclosure.

In some aspects of the present disclosure, partitioning of neural network models is described as one example application of the techniques disclosed herein. However, aspects of the present disclosure are readily applicable to a wide variety of model architectures. Generally, aspects of the present disclosure can be applied to improve hyperparameter optimization for any model architecture that can be partitioned (e.g., that has parameters, such as weights, which can be delineated or partitioned into groups or subsets and trained separately). Additionally, though some examples described below refer to partitioning the model into a defined number of subsets (e.g., three subnets, four subnets, and the like), the model can generally be partitioned into any number of partitions or subsets depending on the particular implementation.

In some aspects, a set of training data can be partitioned or divided into discrete (e.g., non-overlapping) chunks or subsets of training data. In order to estimate the marginal likelihood within a single machine learning model, the system can partition the model's parameters (e.g., weights of a neural network) in correspondence with the training data chunks (e.g., one partition for each subset of training data). Each partition can then be trained using the exemplars from a corresponding subset of training data (or from the corresponding subset and one or more prior subsets, without using training data from subsequent subsets to train the partition, as discussed in more detail below). As discussed in more detail below, each given partition can then be evaluated using one or more unseen subsets of training data (e.g., data that was not use to train the given partition) to generate the marginal likelihood.

### Example Workflow for Hyperparameter Optimization

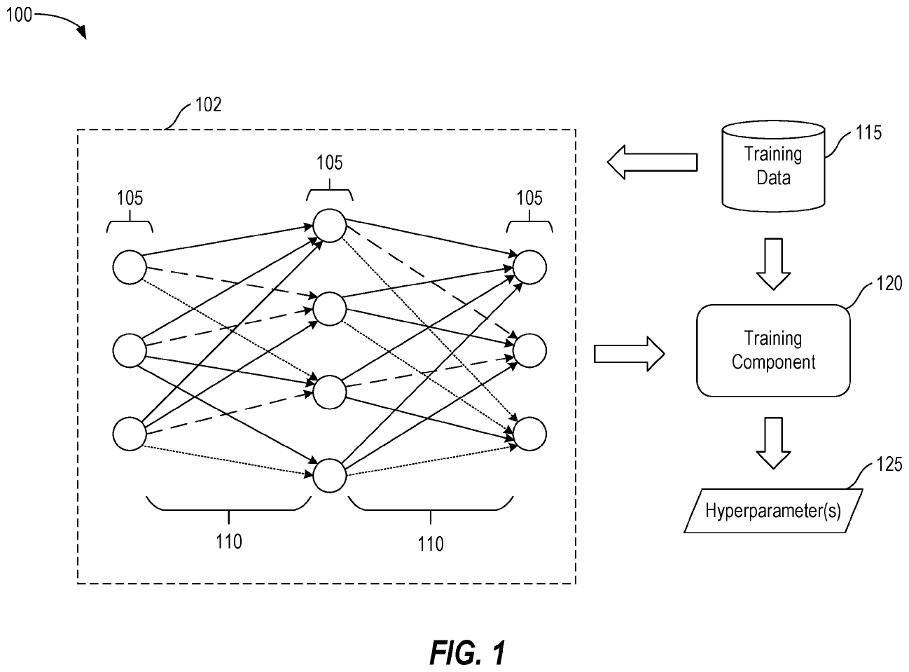

FIG. 1 depicts an example workflow 100 for hyperparameter optimization.

In the illustrated example, a training component 120 accesses or evaluates a machine learning model 102 and a set of training data 115 to generate hyperparameters 125. In an aspect, the workflow 100 corresponds to the training process for the machine learning model 102. That is, the training component 120 can generate the hyperparameters 125 (based on training data 115) while the machine learning model 102 is being trained (e.g., also based on the training data 115). That is, in one aspect, the training component 120 (or another component) may use training data 115 to refine one or more parameters of the machine learning model 102, while also refining one or more hyperparameters 125 using the same training data 115.

For example, the training component 120 (or another component) may pass one or more exemplars from the training data 115 through the machine learning model 102 to generate an output prediction or inference, which can then be compared against the ground-truth label associated with the exemplar to generate a loss. This loss can then be used to refine the parameters of the machine learning model 102 (e.g., using back propagation). In the illustrated workflow, the training component 120 can also use the generated inference and/or loss to approximate the marginal likelihood of the machine learning model 102, as discussed below in more detail, and use this to refine or update the hyperparameters 125. The training component 120 can then begin the next round or epoch of training.

Generally, the workflow 100 may be used to update the parameters and/or hyperparameters 125 using each individual training exemplar separately (e.g., using stochastic gradient descent) or based on batches of training exemplars (e.g., using batch gradient descent).

The training data 115 generally corresponds to any data used to train, refine, or update the machine learning model 102. In some aspects, the training data 115 includes a plurality of training exemplars, where each exemplar includes the input data and a corresponding label or target value (e.g., for supervised learning). In some aspects, the exemplars may not include a target label (e.g., for unsupervised learning). The particular contents of the training data 115 may vary depending on the particular implementation and task. For example, for a computer vision task, each training exemplar may include an image, and the label or target may correspond the desired goal of the model, such as indicating what object(s) the image depicts, the location of one or more specific object(s) in the image, and the like. Though illustrated as residing separately from the training component 120 for conceptual clarity, in some aspects, some or all of the training data 115 may be stored or maintained locally by the training component. Further, though depicted as a single repository for conceptual clarity, in aspects, the training data 115 may be accessed from multiple data sources and/or storages.

The training component 120 may generally be implemented using hardware, software, or a combination of hardware and software, and may be implemented as a discrete system or as part of a larger computing system.

The hyperparameters 125 generally correspond to any variables or values that control the learning process for the machine learning model 102 (as opposed to parameters, which are learned during the training and used during inferencing). For example, the hyperparameters 125 may include variables such as the learning rate, batch size, mini-batch size, weight decay, and the like. In contrast, the model parameters may include variables such as weights and/or biases (e.g., for a neural network architecture) of one or more edges or links in the model.

In the illustrated example, the machine learning model 102 is an artificial neural network. However, as discussed above, aspects of the present disclosure can be readily applied to a wide variety of model architectures. As illustrated, the machine learning model 102 includes a set of nodes 105 and a set of edges 110, where each edge 110 is associated with one or more trainable parameters (e.g., where the value of each parameter is learned based on training data during a training phase). For example, each edge 110 may have a corresponding weight, bias, and the like.

In some aspects, the parameters of each edge 110 are learned based on the training data 115. For example, as discussed above, each training exemplar from the training data 115 may be processed using the machine learning model 102 to generate an output inference, which can then be compared against a ground-truth label to generate a loss that is used to refine the parameters of one or more edges 110.

In the illustrated example, the edges 110 are partitioned into a number of subgroups or subnets, as indicated by solid lines, dashed lines, and dotted lines. That is, a first set of the edges 110 are associated with a first partition or subnet (e.g., the edges 110 having solid lines), a second set of edges 110 are associated with a second partition or subnet (e.g., the edges 110 having dashed lines), and a third set of edges 110 are associated with a third partition or subnet (e.g., the edges 110 having dotted lines). Although the illustrated example includes three discrete subnets, in aspects, the machine learning model 102 may be partitioned into any number of subnets.

In some aspects, the model parameters are partitioned using a random or pseudo-random process, such as by assigning each weight or edge 110 to a partition randomly. In one aspect, if the model is sufficiently large (e.g., if the neural network is sufficiently wide and/or if there are a sufficient number of parameters), then it is generally unlikely that any generated partition orphans any of the nodes 105. That is, all of the partitions are likely to have at least one edge 110 entering each node 105, and at least one edge 110 leaving each node 105, thereby enabling backpropagation during training. However, if such orphaning occurs in any partitions, then the overall training process may remain relatively unaffected (e.g., as long as the number of orphan nodes is low).

In at least some aspects, to prevent orphaning entirely, a variety of steps can be taken. For example, in one aspect, the training component 120 (or another component) can evaluate each partition to ensure there are no orphans prior to beginning training. If any exist, then the training component 120 (or another component) may re-partition the machine learning model 102. As another example, in some aspects, the training component 120 (or another component) may use partitioning techniques that ensure no orphan nodes are created.

Generally, the partitions of the machine learning model 102 may have a correspondence to the partitions of the training data 115 (and vice versa). For example, if the training data 115 is partitioned into K chunks or sets of data, then the machine learning model 102 may be partitioned into K subnets (e.g., by the training component 120). Similarly, if the machine learning model 102 is divided into C subnets, then the training data 115 may be partitioned into C sets of data (e.g., by the training component 120). As discussed above and in more detail below, each partition of the training data 115 has a one-to-one correspondence to a partition of the machine learning model 102.

The parameters associated with any given partition of the machine learning model 102 can then be refined using training exemplars from the corresponding partition of the training data 115 and/or from one or more prior partitions. As used herein, partitions of the training data 115 may be referred to as “prior” or “subsequent” based on a fixed ordering, where the ordering may be randomly assigned or defined at the beginning of training. For example, the corpus of training data 115 may be randomly partitioned (e.g., by the training component 120) into a first set, a second set, a third set, and so on, where the first set is “prior to” the second and third sets, and the third set is “subsequent to” the first and second sets.

In some aspects, the subnets or model partitions may similarly be ordered based on this ordering of the training data subsets. For example, each model partition may be assigned to or otherwise associated with a specific set of training data, where the model partitions can inherit the ordering of the training data. In this way, a subnet or model partition may similarly be referred to as “prior” or “subsequent” for conceptual clarity.

For example, the first model partition (e.g., indicated by edges 110 depicted using solid lines) may be trained using data for a first subset of the training data 115. The second model partition (e.g., indicated by edges 110 depicted using dashed lines) may be trained using either only data from a second (non-overlapping) subset of the training data 115, or based on the second subset of training data 115 and all (or at least some) prior subsets (e.g., the first subset) combined. As discussed above and in more detail below, by using non-overlapping sets of the training data 115 to train the model partitions, the training component 120 is able to efficiently approximate the marginal likelihood of the machine learning model 102. That is, because each partition of the machine learning model 102 is trained on a proper subset of the training data 115, some or all of the training data 115 that each partition has not been trained on (e.g., any subsequent subsets of training data 115) can be used to efficiently approximate marginal likelihood, as discussed in more detail below.

In some aspects, the machine learning model 102 is partitioned into disjoint (non-overlapping) subnets. In other aspects, the machine learning model 102 may be partitioned into overlapping subnets. For example, a first subnet may correspond to the solid edges 110, a second subnet may correspond to the combination of the solid edges 110 and the dashed edges 110, and a third subnet may correspond to all of the edges 110. That is, if the machine learning model 102 has a set of parameters w, then these parameters may be partitioned into disjoint sets (w₁, w₂, . . . , w_{c}). Each subnet may then include a single set of the parameters (e.g., a subnet for w₁, a subnet for w₂), and the like, or may include partially overlapping parameters (e.g., a subnet for w₁, a subnet for w₁ and w₂ combined, and so on).

In an aspect, even if the subnets overlap, then the training component 120 may still optimize the model parameters with respect to each specific partition. For example, if the second subnet includes parameters w₁ and w₂, then the training component 120 may nevertheless update or refine the parameters w₂, while keeping the parameters w₁ fixed or frozen, when training the second subnet (e.g., because the parameters w₁ are learned while training the first subnet, and the second set of training data 115 used to refine the parameters of the second subnet (w₂) should not be used to change the parameters of the first subnet (w₁)).

For example, in the illustrated example, the parameters w of the machine learning model 102 are partitioned into sets (w₁, w₂, w₃) (e.g., indicated by solid lines, dashed lines, and dotted lines, respectively). The three subnets may then be defined as subnet₁=(w₁, 0,0), subnet₂=(0, w₂, 0), and subnet₃=(0,0, w₃), or as subnet₁=(w₁, 0,0), subnet₂=(w₁, w₂, 0), and subnet₃=(w₁, w₂, w₃). Further, the training data 115 [symbol] may be similarly partitioned into three subsets [symbol] ₁, [symbol] ₂, and [symbol] ₃.

To train the machine learning model 102, the training component 120 may use [symbol] ₁ to train subnet₁, such as by computing a loss with respect to data [symbol] ₁ and parameters in subnet₁ (e.g., [symbol] ( [symbol] ₁, subnet₁) and using the loss to update the parameters w₁, Similarly, the training component 120 may use [symbol] ₂ and/or [symbol] ₁ train subnet₂, such as by computing a loss with respect to data [symbol] ₂ and/or [symbol] ₁ and parameters in subnet₂ (e.g., [symbol] ( [symbol] ₁ and [symbol] ₂, subnet₂) and using the loss to update the parameters w₂, and use [symbol] ₃, [symbol] ₂, and/or [symbol] ₁ to train subnet₃, such as by computing a loss with respect to data [symbol] ₃, [symbol] ₂, and/or [symbol] ₁ and parameters in subnet₃ (e.g., [symbol] ( [symbol] ₁ and [symbol] ₂ and [symbol] ₃, subnet₃) and using the loss to update the parameters w₃.

In this way, the c-th subnet of the machine learning model 102 (or the c-th partition of parameters) is trained using data from the corresponding c-th chunk of the training data 115 (and, in some aspects, the prior (1, . . . , c−1)-th chunks of training data 115).

In the illustrated workflow 100, once each subnet of the machine learning model 102 is so trained, the training component 120 can generate a marginal likelihood estimate or approximation for the model by evaluating the performance of each given partition/subnet using data from a subsequent partition of training data 115 (that was not seen or used to refine weights of the given subnet during training). For example, if a subnet was trained using data partition Dc, then the marginal likelihood may be estimated by computing a loss (e.g., the test log-likelihood) for the subnet using data partition [symbol] _{c+1}. Continuing the above example, the training component 120 may generate a first loss for the first subnet (trained solely on data [symbol] ₁) using the data [symbol] ₂ (e.g., [symbol] ( [symbol] ₂, subnet₁)), a second loss for the second subnet (trained solely on data [symbol] ₂ and/or [symbol] ₁) using data [symbol] ₃ (e.g., [symbol] ( [symbol] ₃, subnet₁)), and so on.

More generally, the approximated marginal likelihood for the machine learning model 102 may be generated using equation 1 below, where C is the number of partitions/subsets of the training data 115 and machine learning model 102, [symbol] ᵢ is the i-th partition of the training data 115, [symbol] _{1:i-1} is the aggregate of the data from the first partition of the training data 115 through the (i−1)-th partition of the training data 115, w is the parameters of the machine learning model 102, q(w| [symbol] _{1:i-1}) is the approximate posterior distribution over the parameters w conditioned on the subsets of data [symbol] _{1:i-1}, [symbol] _{w˜q(w)} is the expectation with respect to samples of parameters w drawn from a probability distribution q(w), and p( [symbol] ᵢ|w) is the probability of the exemplars in the [symbol] ᵢ subset of training data 115 given the model parameters w.

$${\sum }_{i = 1}^{C} log {𝔼}_{w \sim q ( w \vert {𝒟}_{1 : i - 1} )} [ p ( {𝒟}_{i} \vert w ) ] \qquad ( 1 )$$

In some aspects, the approximate posterior distribution q(w| [symbol] _{1:i-1}) is a point-estimate of the weights w obtained by training a subnet of the machine learning model 102 using a subset of the data [symbol] _{1:i-1}.

As discussed above, the approximated marginal likelihood can then be used (e.g., by the training component 120) to generate, update, or refine one or more hyperparameters 125 for the machine learning model 102. These updated hyperparameters 125 can then be used to further train the machine learning model 102 (e.g., during a subsequent round or epoch of training), thereby significantly improving model performance.

Although not included in the illustrated example, in some aspects, once the machine learning model 102 is trained (e.g., after one or more rounds or epochs of training), the entire model can then be used for runtime inferencing, and the hyperparameters 125 may be discarded, stored, or otherwise not used. Similarly, the partition delineations may be deleted, removed, or ignored. For example, the machine learning model 102, including the nodes 105 and edges 110 (e.g., all parameters from all partitions of the model) may be deployed to generate output predictions or inferences based on input data during runtime. Generally, the machine learning model 102 may be deployed for inferencing on the same system that performs the training, and/or one or more other systems.

### Example Workflows for Hyperparameter Optimization Using Partitioned Machine Learning Models

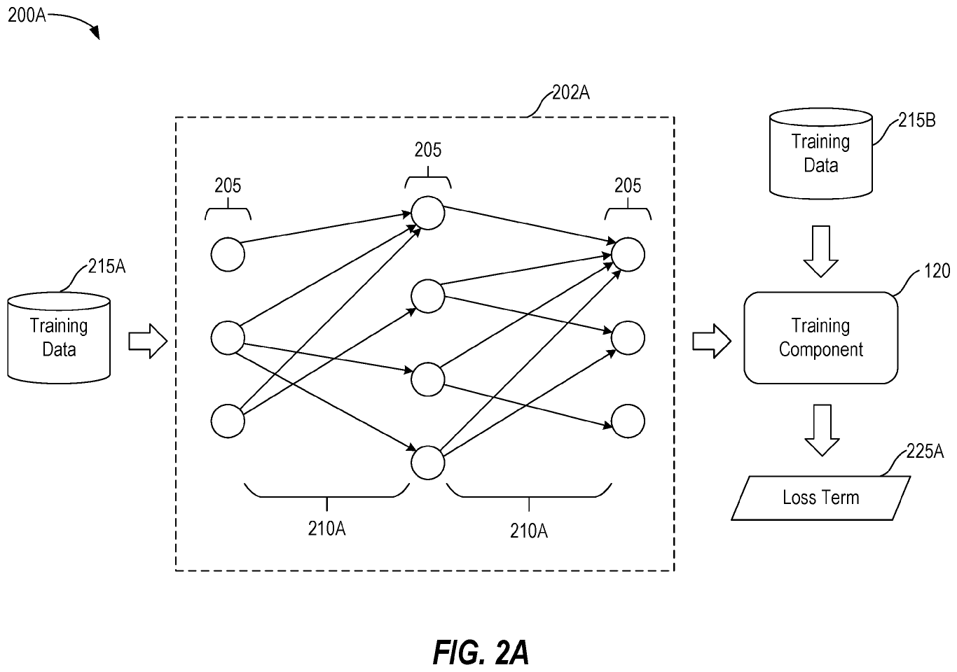

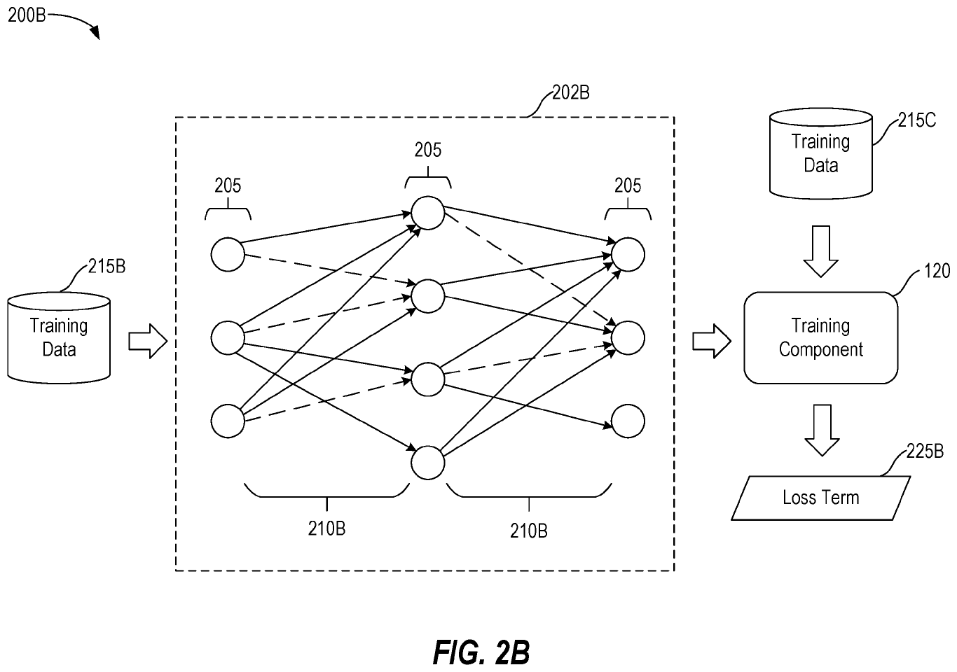

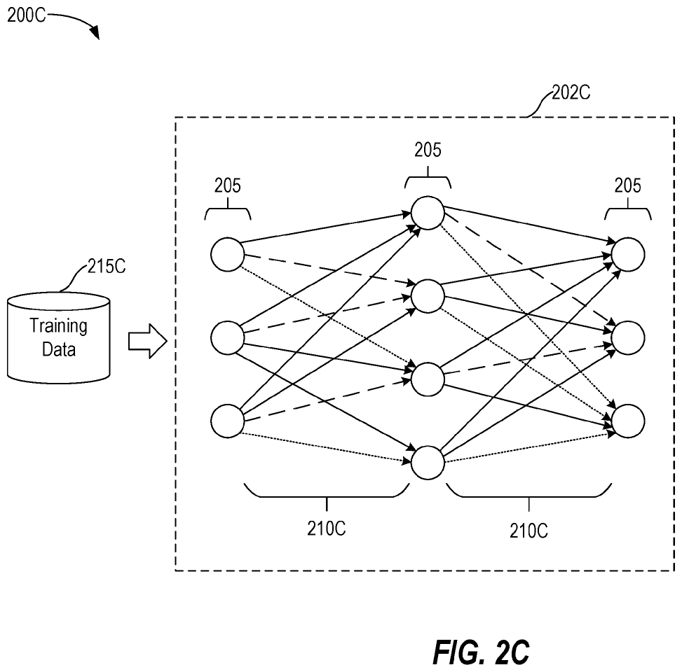

FIGS. 2A, 2B, and 2C depict example workflows to perform hyperparameter optimization using partitioned machine learning models. In some aspects, the workflows 200A, 200B, and 200C of FIGS. 2A, 2B, and 2C depict additional detail for the workflow 100 of FIG. 1.

As illustrated in FIG. 2A, a first set of training data 215A is used to train a first subnet 202A of a machine learning model, where the subnet 202A includes a set of nodes 205 and edges 210A. For example, as discussed above, the training component 120 may process each exemplar in the training data 215A to generate a corresponding inference, compare this inference against a corresponding ground-truth, and refine or update the parameters of the edges 210A in the subnet 202A based on the difference or loss. For example, as discussed above, a first data partition [symbol] ₁ may be used to train a first subnet or set of weights w₁.

In some aspects, while training the subnet 202A, the training component 120 can ignore any parameters (e.g., edges or weights) that are not included in the subnet 202A. That is, the training component 120 may process the training data 215A during the forward pass as if the non-included edges do not exist, may use a value of zero for the weights of the non-included edges, and the like. More generally, when training any given partition, the training component 120 can exclude, ignore, refrain from processing, or use a fixed value of zero to represent any edges (or other parameters) that are not included in the partition.

In at least one aspect, rather than ignoring or deleting such edges or parameters when training the subnet 202A, the training component 120 can instead retain these edges/parameters, and use the values that were used to initialize the non-included edges. For example, if the parameters are initialized to random values, then the training component 120 may use these random values for any non-included edges during the forward pass. In some aspects, this can improve training stability.

After being trained, as illustrated, a second set of training data 215B is then used, in conjunction with the trained subnet 202A, to generate a first loss term 225A (e.g., the test log-likelihood, computed by processing the training data 215B using the subnet 202A). Notably, the training data 215B does not overlap with the training data 215A. That is, the data used to generate the loss term 225A for the first subnet 202A (which is used to generate the approximated marginal likelihood for the model) does not include any data that was used to train or refine the parameters of the subnet 202A. For example, as discussed above, a second data partition [symbol] ₂ may be used to evaluate the subnet/partition of weights w₁.

As illustrated in FIG. 2B, the second set of training data 215B is also used to train a second subnet 202B of the machine learning model, where the subnet 202B includes the set of nodes 205 and a set of edges 210B. For example, as discussed above, the training component 120 may process each exemplar in the training data 215B to generate a corresponding inference, compare this inference against a corresponding ground-truth, and refine or update the parameters of some or all of the edges 210B in the subnet 202B based on the difference or loss. For example, as discussed above, a second data partition [symbol] ₂ may be used to train a first subnet or set of weights w₂.

In the illustrated example, the subnet 202B includes both the first set of parameters w₁ (corresponding to the first subnet 202A), as indicated using solid lines, as well as a second set of parameters w₂, as indicated using dashed lines. In some aspects, while training the subnet 202B, the training component 120 may use the training data 215B to refine the second set of parameters w₂, leaving the first set w₁ unchanged.

Additionally, though the illustrated example depicts training the subnet 202B using the training data 215B, in some aspects, the training component 120 can additionally use prior exemplars as well. For example, the second subnet 202B may be further trained based on the training data 215A that was used to train the first subnet 202A.

After being so trained, as illustrated, a third set of training data 215C is then used, in conjunction with the trained subnet 202B, to generate a second loss term 225B (e.g., the test log-likelihood, computed by processing the training data 215C using the subnet 202B). Notably, as discussed above, the training data 215C does not overlap with the training data 215B and/or the training data 215A. That is, the data used to generate the loss term 225B for the second subnet 202B (which is used to generate the approximated marginal likelihood for the model) does not include any data that was used to train or refine the parameters of the subnet 202B. For example, as discussed above, a third data partition [symbol] ₃ may be used to evaluate the subnet/partition of weights w₂.

In some aspects, the loss term 225B can be aggregated with the loss term 225A (e.g., using summation) to generate the estimated or approximated marginal likelihood for the aggregate model (including both subnets 202A and 202B).

As illustrated in FIG. 2C, the third set of training data 215C is also used to train a third subnet 202C of the machine learning model (which may correspond to the entire model), where the subnet 202C includes the set of nodes 205 and a set of edges 210C. For example, as discussed above, the training component 120 may process each exemplar in the training data 215C to generate a corresponding inference, compare this inference against a corresponding ground-truth, and refine or update the parameters of some or all of the edges 210C in the subnet 202C based on the difference or loss. For example, as discussed above, a third data partition [symbol] ₃ may be used to train a third subnet or set of weights w₃.

In the illustrated example, the subnet 202C includes the first set of parameters w₁ (corresponding to the first subnet 202A), as indicated using solid lines, the second set of parameters w₂ (corresponding to the second subnet 202B), as indicated using dashed lines, as well as a third set of parameters w₃, as indicated using dotted lines. In some aspects, while training the subnet 202C, the training component 120 may use the training data 215C to refine the third set of parameters w₃, leaving the first set w₁ and second set w₂ unchanged.

Additionally, though the illustrated example depicts training the subnet 202C using the training data 215C, in some aspects, the training component 120 can additionally use prior exemplars as well. For example, the third subnet 202C may be further trained based on the training data 215A (used to train the first subnet 202A) and/or the training data 215B (used to train the second subnet 202B).

In the illustrated example, after being so trained, the subnet 202C (or the aggregate of the subnets in the model) can be used for inferencing (if training is complete). However, as no further partitions of training data remain (e.g., there were three sets of training data in the illustrated workflows), the final subnet 202C cannot be used to generate the approximated marginal likelihood. In a similar way, though the approximated marginal likelihood is generated based on the second and third sets of training data 215B and 215C, the first set of training data 215A is used for training and is not used to generate the approximate marginal likelihood (e.g., because there is no 0-th subnet, and all subnets in the model may have been trained based on the training data 215A).

As discussed above, the individual loss terms 225A and 225B from one or more subnets 202 can then be combined (e.g., summed) to generate the approximate marginal likelihood, and this approximated marginal likelihood can then be used to refine one or more hyperparameters of the model (e.g., variables used to control the training process). These updated hyperparameters (as well as the updated parameters themselves) can then be used in a subsequent round of training.

In this way, aspects of the present disclosure enable the hyperparameters to be jointly learned alongside the parameters themselves and using the single set of training data 215 (partitioned into subsets). This significantly reduces the amount of data relied on to refine the hyperparameters (e.g., eliminating the use of distinct validation data), improves computational efficiency of the training (e.g., reducing computational expense and latency), and generally improves the accuracy and performance of the final model (e.g., through higher prediction accuracy achieved using the optimized hyperparameters).

Although not included in the illustrated workflows 200, in some aspects, the training process can be distributed across a number of devices, such as in a federated learning system. In one such aspect, each subnet of the model may be trained by a corresponding client (or group of clients) in the federated system using the client's corresponding local training data. For example, the subnet 202A may be trained by a first set of client(s) using the clients' local data, the second subnet 202B may be trained by a second set of client(s) using the clients' local data, and so on. To generate the loss terms 225 used to generate the approximated marginal likelihood, in some aspects, each client can process its local data using the (c−1)th subnet. That is, if a given client is training the cth subnet, then the prior subnet (the (c−1)th subnet) can be used to generate the loss term.

In some aspects, to reduce network congestion and consumed bandwidth, the federated learning system may transmit a proper subset of the model to each client. For example, for clients in group c (that train the cth subnet), the central server may transmit subnetwork weights from subnets 1 to c (as opposed to transmitting the entire model), refraining from transmitting subnets from c+1 to C. This reduces overhead, as the amount of data transmitted to each client is, on average, less than the entire model. Each client can then return the updates (e.g., parameter gradients and/or hyperparameter gradients) to the central server, which may aggregate them to generate an updated model. This process can similarly be repeated until training is complete.

### Example Method for Hyperparameter Optimization Using Partitioned Machine Learning Models

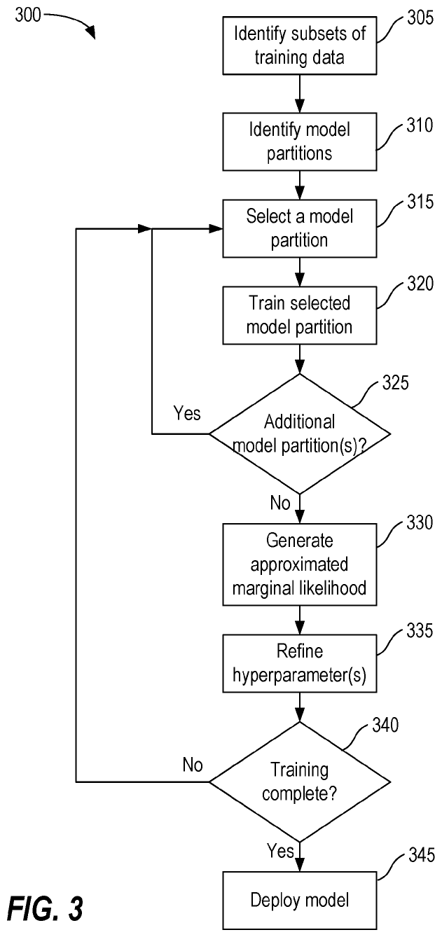

FIG. 3 is a flow diagram depicting an example method 300 for hyperparameter optimization using partitioned machine learning models. In some aspects, the method 300 is performed by a training component, such as training component 120 of FIGS. 1, 2A, 2B, and/or 2C.

At block 305, the training component identifies two or more subsets of training data (e.g., training data 115 of FIG. 1). In some aspects, as discussed above, identifying the subsets of training data can include actively partitioning or dividing the training data into subsets (e.g., where the training data is a single corpus or repository). In some aspects, as discussed above, identifying the training data can additionally or alternatively include identifying or determining predefined or pre-created partitions or subsets, such as where the data is partitioned by another system, by a user, or is inherently/structurally partitioned (e.g., in a federated learning system, where each client has its own local data, these distinct sets of data are already partitioned).

In some aspects, the number of subsets used can vary depending on the particular implementation. For example, a user or other system may specify the number of subsets that should be used, and the training component may partition the training data into the indicated number of subsets. Generally, any number of partitions may be used.

In some aspects, the techniques used to partition the training data may vary depending on the particular implementation. For example, in at least one aspect, the data is partitioned using a random or pseudo-random process, such that the data within each subset is random. Similarly, the sizes of each subset may differ depending on the particular implementation. For example, the training component may partition the data equally (such that each subset is equal, or approximately equal, in size), or may partition the data unequally (such that some subsets are larger than others).

At block 310, the training component identifies two or more model partitions (e.g., subnets) from a machine learning model being trained. As discussed above, each model partition generally corresponds to a subset of trainable parameters from the model. For example, in the case of a neural network, each model partition may be a subnet (e.g., a subset of the weights), where the partitions collectively comprise the entire network.

In some aspects, as discussed above, identifying the partitions of the model can include actively partitioning or dividing the model parameters into subsets. In some aspects, as discussed above, identifying the partitions can additionally or alternatively include identifying or determining predefined or pre-created partitions or subsets of the model parameters. In an aspect, as discussed above, the number of model partitions may generally be equal to the number of subsets of training data.

In some aspects, the techniques used to partition the model parameters may vary depending on the particular implementation. For example, in at least one aspect, the parameters are partitioned using a random or pseudo-random process, such that the specific parameters within each partition is random. Similarly, the sizes of each partition may differ depending on the particular implementation. For example, the training component may partition the model equally (such that each partition is of equal, or approximately equal, size), or may partition the model unequally (such that some subnets are larger than others).

In some aspects, as discussed above, each subnet includes the parameters from a corresponding partition of the model. For example, if the model is partitioned into subsets of parameters {w₁, w₂, . . . , w_{c}}, then each subnet may correspond to the parameters from one such subset. In at least one aspect, as discussed above, each subnet may optionally include the parameters from one or more prior subsets. For example, the ith subnet may include parameters {w₁, w₂, . . . , wᵢ₋₁, wᵢ}.

At block 315, the training component selects one of the model partitions. Generally, the training component may use any suitable technique or approach to select the model partition, as all model partitions will be processed using the method 300. In at least one aspect, the training component selects the partitions sequentially. For example, the training component may first select the first partition (e.g., the subnet having a single set of weights w₁), followed by selecting the second partition (e.g., including both weights w₂ and weights w₁), and the like. In this way, the training component can train the parameters of a given subnet, and use these trained parameters to form part of the subsequent subnet(s) for the current round and/or for a future round of training. In other aspects, the training in a given round can be used to refine weights/parameters from the prior round (as opposed to using updated weights in earlier subnets when refining weights in subsequent subnets).

Although the illustrated example depicts a sequential process (selecting each partition in turn) for conceptual clarity, in some aspects, some or all of the partitions may be selected and processed in parallel. For example, the training component may train non-overlapping partitions or subnets in parallel (while training overlapping subnets in sequence based on the subnet dependencies), or may use the previous parameters (from the previous round of training) to perform the current round of training for all subnets.

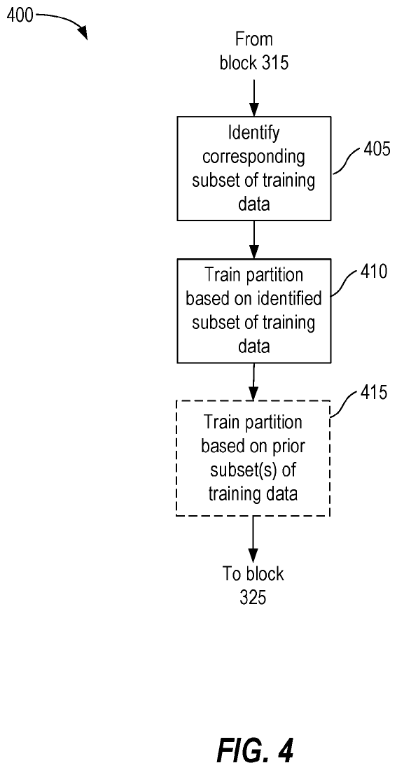

At block 320, the training component trains the selected model partition based on the corresponding subset of training exemplars (or based on the corresponding subset and any prior subset(s) used to train prior model partitions). For example, as discussed above, the training component may use training data [symbol] _{c} to train the cth partition, and may (optionally) use training data [symbol] _{1:c-1} to further train the cth partition. One example of training the selected partition is discussed in more detail below with reference to FIG. 4.

At block 325, the training component determines whether there is at least one additional model partition remaining to be trained. If so, then the method 300 returns to block 315. If not (e.g., if all the parameters of the model have been trained or refined for the current epoch or training round), then the method 300 continues to block 330.

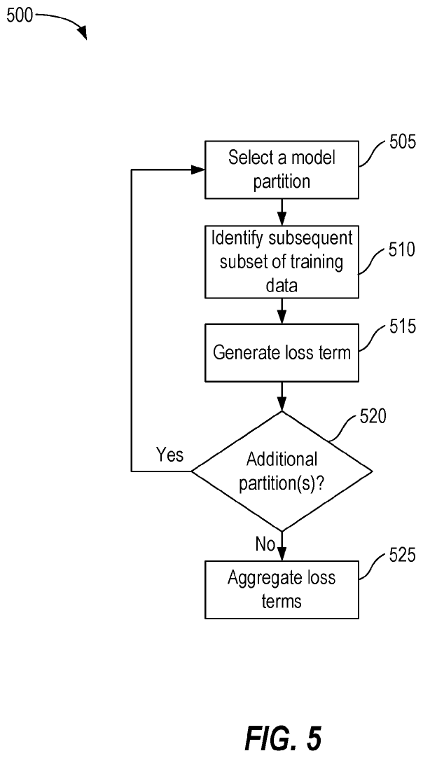

At block 330, the training component generates an approximate or estimated marginal likelihood for the machine learning model based on the partitions. For example, as discussed above, the training component may generate a test loss (e.g., test log-likelihood) for each partition using training data used to train the subsequent partition(s) (e.g., using the data [symbol] _{c+1} to generate a test loss for the cth partition). By aggregating these test losses for one or more of the partitions, the training component can efficiently approximate the marginal likelihood of the model. One example technique for generating the approximated marginal likelihood is discussed in more detail below with reference to FIG. 5.

At block 335, the training component can then refine the hyperparameter(s) of the model based on the approximated marginal likelihood. Generally, the particular techniques or operations used to refine the hyperparameters may vary depending on the particular implementation and the particular hyperparameter(s) being refined.

For example, for a hyperparameter that defines a mask over input data (e.g., where a parameterized stochastic mask, such as one defined using a Bernoulli distribution or a continuous relaxation of the Bernoulli distribution, is applied to input data), the system may use the marginal likelihood estimate to refine the parameters of this distribution.

As another example, for a hyperparameter relating to data augmentations (e.g., rotations on input images), a differentiable affine augmentation operation may be used (parameterized using hyperparameters) to generate the augmented input data, and the augmentation parameters may be refined using the marginal likelihood estimate.

At block 340, the training component determines whether training is complete (e.g., whether one or more termination criteria are satisfied). In aspects, the termination criteria may vary depending on the particular implementation, and may include variables such as a maximum number of training iterations, a minimum model accuracy, and the like. If training is not complete, then the method 300 returns to block 315 to begin the next iteration. If training is complete, then the method 300 continues to block 345.

At block 345, once the machine learning model is trained, the training component deploys the model for inferencing. In some aspects, the training hyperparameters may be discarded, stored, or otherwise not used, as these hyperparameters are not used during inferencing. In an aspect, deploying the trained model includes deploying the entire set of parameters, irrespective of the parameter partitioning used during training. That is, the partition delineations may not be used or referred to during inferencing, though the delineations are relevant during training. The deployed model can then be used to generate output predictions or inferences based on input data during runtime. Generally, deploying the model may include instantiating the model locally for inferencing on the same system that performed the training, and/or one or more other systems.

### Example Method for Training Machine Learning Model Partitions for Hyperparameter Optimization

FIG. 4 is a flow diagram depicting an example method 400 for training machine learning model partitions for hyperparameter optimization. In some aspects, the method 400 is performed by a training component, such as training component 120 of FIGS. 1, 2A, 2B, and/or 2C. In some aspects, the method 400 provides additional detail for block 320 of FIG. 3.

At block 405, the training component identifies a corresponding set of training data for the model partition that is currently being trained. As discussed above, in an aspect, there is a one-to-one correspondence between model partitions and training data subsets, such that each subset corresponds to a single partition and each partition corresponds to a single training subset. For example, when training the cth partition, the training component can identify the cth subset of training exemplars.

At block 410, the training component trains the selected partition based on the identified subset of the training data. Generally, the particular operations used to train the partition may vary depending on the particular implementation and model architecture. For example, to train a neural network partition (e.g., a subnet), the training component may process a training exemplar (from the subset of exemplars) using the subnet (e.g., using the subset of edges or parameters that are included in the subnet) to generate an output inference. This output inference can be processed, alongside a ground-truth value for the exemplar, to generate a loss, which can then be used to generate parameter gradients to refine the parameters of the subnet (e.g., using batch gradient descent or stochastic gradient descent).

As discussed above, in some aspects, training the identified model partition may correspond to updating a single subset of the model parameters, even if the partition includes multiple subsets. For example, suppose a first subnet includes a first set of weights, and a second subnet includes both the first set of weights and a second set of weights. In an aspect, training the second partition may include refining only the second set of weights (where the first set of weights are refined while training the first partition based on another set of training data).

At block 415, the training component can optionally train the selected partition based on one or more prior subsets of training data, if any exist. For example, for the cth model partition, the training component may use exemplars from the previous subsets (e.g., [symbol] _{1:c-1}) to refine the partition parameters of the selected partition.

In this way, the training component can train each partition of the model using a corresponding subset (or subsets) of the training data, allowing the marginal likelihood of the overall model to be determined by using each given partition to process unseen training data (e.g., a subset that was not used to train the parameters of the given partition). This enables efficient and accurate hyperparameter optimization to be performed, thereby improving model accuracy without incurring substantial overhead.

Example Method for Approximating Marginal Likelihood to Enable Improved Hyperparameter Optimization using Partitioned Machine Learning Models

FIG. 5 is a flow diagram depicting an example method 500 for approximating marginal likelihood to enable improved hyperparameter optimization using partitioned machine learning models. In some aspects, the method 500 is performed by a training component, such as training component 120 of FIGS. 1, 2A, 2B, and/or 2C. In some aspects, the method 500 provides additional detail for block 330 of FIG. 3.

At block 505, the training component selects a partition from the machine learning model being trained. Generally, the training component may use any suitable technique or approach to select the model partition, including randomly or pseudo-randomly. As discussed below in more detail, in some aspects, the training component may select from among a subset of the partitions. For example, in at least one aspect, the last model partition (which may comprise the final set of parameters w_{c} and/or the entire model) is not used to generate the marginal likelihood, as there is not “subsequent” set of data (e.g., because the final partition may be trained on all of the training data subsets, leaving no unseen exemplars to evaluate the marginal likelihood).

In at least one aspect, the training component selects the partitions sequentially. For example, the training component may first select the first partition (e.g., the subnet having a single set of weights w₁), followed by selecting the second partition (e.g., including both weights w₂ and weights w₁), and the like. Although the illustrated example depicts a sequential process (selecting each partition in turn) for conceptual clarity, in some aspects, some or all of the partitions may be selected and processed in parallel to generate the approximate marginal likelihood.

At block 510, the training component identifies one or more subsequent subsets of training data, with respect to the selected partition. As discussed above, training data may generally be referred to as “subsequent” if this data was not used to train or refine the parameters of the selected subset. For example, for the cth subnet, the training component may identify the (c+1)th subset of training data (e.g., the training data used to train the (c+1)th subnet).

Although some examples described herein refer to evaluating each model partition using the subsequent partition of training data, in some aspects, the model partitions may be trained and/or evaluated using any training data partition(s), as long as the test set (used to generate gradients to refine the hyperparameters) is not included in the training set (used to refine the parameters of the partition). For example, the training component may evaluate each model partition using all subsequent partitions of training data, or may train the model partition using a single partition of training data (as opposed to all prior sets), and evaluate the model partition using one or more prior partitions of training data. More generally, the training component may, at block 510, identify any partition or subset of training data that was not used to train or refine the parameters of the selected model partition. In some aspects, such selections may be described or discussed as cross-validation objectives more generally, rather than approximated marginal likelihoods, specifically.

At block 515, the training component uses this identified subsequent subset of data to generate a loss term using the selected model partition. For example, the training component may generate the loss (e.g., the test log-likelihood) by processing the identified subset (e.g., [symbol] _{c+1}) using the partition (e.g., w_{1:c}). As discussed above, the process of generating the loss may vary depending on the particular implementation and model architecture. For example, in the case of a neural network, the training component may process each given exemplar in the identified subset [symbol] _{c+1} using the selected subnet w_{1:c} to generate an output inference, and compare this output inference against the corresponding label of the exemplar to generate the loss (e.g., a test log-likelihood).

At block 520, the training component determines whether there is at least one additional model partition remaining. That is, the training component determines whether there is at least one partition, from the partitions that are used to generate the approximate marginal likelihood, that has not-yet been used. For example, as discussed above, in some aspects, the training component does not use the final subnet (e.g., the total set of weights), as this partition has already been trained on the entire set of training data and there is no unseen data to be used in approximating the marginal likelihood.

If at least one partition remains, then the method 500 returns to block 505. If all partitions (that can be used to generate the marginal likelihood) have been used to generate a corresponding loss term, then the method 500 continues to block 525. At block 525, the training component aggregates the loss terms generated for each partition to generate an overall approximated or estimated marginal likelihood for the model. For example, as discussed above, the training component may sum the loss terms, determine the average of the loss terms, and the like.

As discussed above, this efficiently-generated approximated marginal likelihood can then be used to refine one or more hyperparameters of the model. For example, the training component may use the approximate marginal likelihood to generate gradient(s) for each hyperparameter, and update each hyperparameter accordingly.

### Example Method for Parameter and Hyperparameter Optimization Using Federated Learning

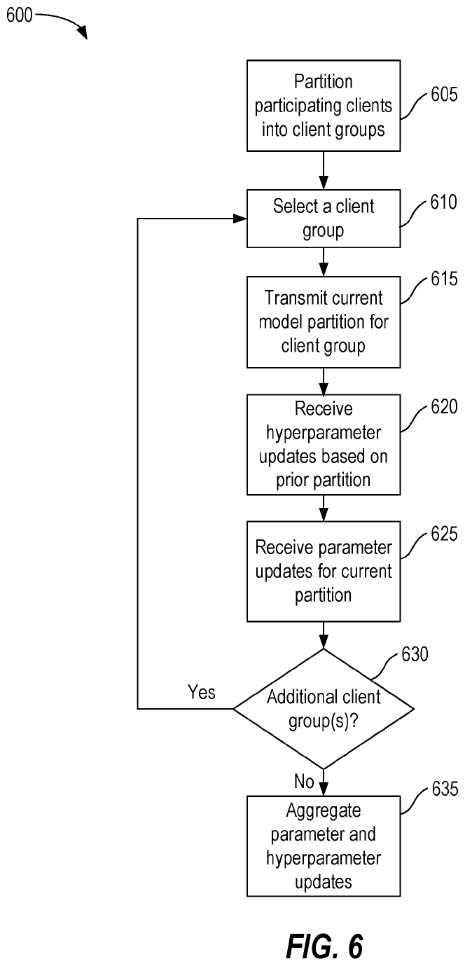

FIG. 6 is a flow diagram depicting an example method 600 for parameter and hyperparameter optimization using federated learning. In some aspects, the method 600 is performed by a training component, such as training component 120 of FIGS. 1, 2A, 2B, and/or 2C. For example, the training component may operate on a central server or host that manages the federated learning.

At block 605, the training component partitions the set of participating clients into a set of client groups. In at least one aspect, the training component partitions the clients based on the desired or defined number of model partitions and/or subsets of training data. For example, if there are (or will be) C subnets in the model, then the training component can partition the clients into C client groups. In some aspects, this client partitioning can be performed using any suitable technique, including randomly or pseudo-randomly. In some aspects, the training component generates the client groups uniformly and randomly (e.g., such that there are an equal number of clients in each group).

In at least one aspect, the training component can generate the groups to distribute training exemplars uniformly among the groups. That is, the training component may generate the groups such that each client group may have any number of clients, so long as the total number of exemplars associated with the clients in each group is roughly uniform or equal between groups. In some aspects, if new clients are added to the federation during training, then the training component can assign them to one of the pre-existing client groups using similar techniques (e.g., randomly, or in an effort to balance the groups).

At block 610, the training component selects one of the client groups from the set created at block 605. Generally, the training component can select the client group using any criteria, including randomly or pseudo-randomly, as the training component will select and process each client group during each iteration or round of federated learning. Additionally, though the illustrated example depicts sequential selection of each client group in turn, in some aspects, the training component can select and process some or all of the client groups in parallel.

At block 615, the training component transmits the current model partition, which corresponds to the selected client group, to some or all of the clients in the selected group. In some aspects, the training component may randomly select one or more clients in each client group, and transmit the model partition to these selected clients for the current round.

In some aspects, the training component can transmit the current version of the entire machine learning model to the client(s) in the selected client group. In at least one aspect, the training component transmits a proper subset of the model. In one such aspect, the training component may transmit the partition of the model that corresponds to the selected group. For example, for the cth client group, the training component may identify and transmit the cth partition or subnet, which may include the parameters w_{c}, and/or may include the prior parameters w_{1:c}. In this way, the total bandwidth consumed can be reduced, as compared to conventional federated learning systems that transmit the entire model to all participating clients.

Upon receiving the partition, each participating client in the selected client group can then perform local optimization/training on the parameters specific to the client group/partition (e.g., on w_{c}), as discussed above, using the client's local training data. These parameter updates (e.g., updated parameters and/or parameter gradients) can then be returned to the central server.

Further, each local client can use its local training data to generate an approximated marginal likelihood or loss term, such as by processing the client's local data using the prior partition(s), which may be included in the transmission at block 615. For example, for a client in the cth group, the client may generate an approximated marginal likelihood for the prior partition w_{1:c-1} using the client's local data, and generate hyperparameter gradients or updates based on this marginal likelihood.

At block 620, the training component receives the hyperparameter updates (e.g., gradients), generated based on the prior partition of the model, relative to the current group, from each participating client in the selected client group. For example, the training component may average, sum, or otherwise combine the hyperparameter updates provided by the clients. Further, at block 625, the training component receives parameter updates (e.g., gradients), generated for the current partition that corresponds to the client group, from each participating client. For example, the training component may average, sum, or otherwise combine the parameter updates provided by the clients.

In an aspect, the training component can aggregate and use these updates from each client to generate an updated version of the model partition that corresponds to the selected client group. This updated version can then be distributed during the subsequent iteration of the federated learning, if one is performed.

At block 630, the training component determines whether there is at least one additional client group that has not-yet been processed during the current iteration of the federated learning. If so, then the method 600 returns to block 610. If not, then the method 600 continues to block 635.

At block 635, the training component can aggregate the hyperparameter and parameter updates received from each client group in order to generate a refined or updated version of the model, as well as a refined or updated set of hyperparameters. For example, the training component may sum or average the updates from each client group in order to yield overall updates, which are used to update the model as discussed above. In some aspects, the training component can then begin a new iteration of the federated learning (e.g., returning to block 610).

In some aspects, the subsequent round of training is performed by selecting a subset of clients from each group and transmitting the updated model to each. In at least one aspect, the training component may optionally keep track of the history of client selections, such that just those parameters that have been updated since the last communication with each client can be transmitted at the current iteration.

In this way, the training component can perform federated learning that enables efficient hyperparameter optimization using approximated marginal likelihood for partitioned machine learning models.

### Example Method for Refining Hyperparameters for Partitioned Machine Learning Models

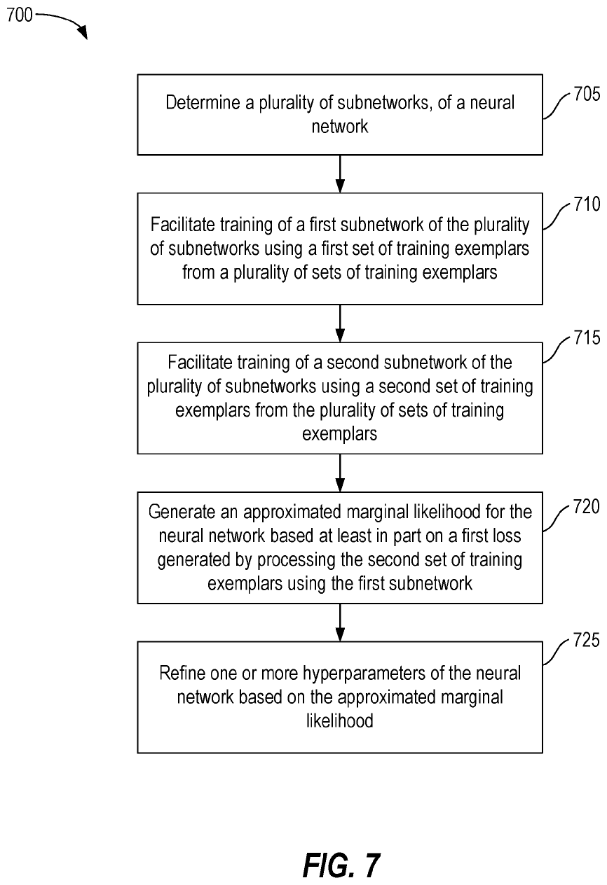

FIG. 7 is a flow diagram depicting an example method 700 for refining hyperparameters for partitioned machine learning models. In some aspects, the method 700 is performed by a training component, such as training component 120 of FIGS. 1, 2A, 2B, and/or 2C.

At block 705, a plurality of subnetworks, of a neural network, is determined.

At block 710, training of a first subnetwork of the plurality of subnetworks is facilitated using a first set of training exemplars from a plurality of sets of training exemplars.

At block 715, training of a second subnetwork of the plurality of subnetworks is facilitated using a second set of training exemplars from the plurality of sets of training exemplars.

At block 720, an approximated marginal likelihood for the neural network is generated based at least in part on a first loss generated by processing the second set of training exemplars using the first subnetwork.

At block 725, one or more hyperparameters of the neural network are refined based on the approximated marginal likelihood.

In some aspects, determining the plurality of subnetworks comprises partitioning parameters of the neural network based on defined grouping criteria.

In some aspects, the method 700 further includes partitioning a corpus of training exemplars into the plurality of sets of training exemplars.

In some aspects, the method further comprises facilitating training of a third subnetwork of the plurality of subnetworks using a third set of training exemplars from the plurality of sets of training exemplars, and generating the approximated marginal likelihood for the neural network based further on summing the first loss and a second loss generated by processing the third set of training exemplars using the second subnetwork.

In some aspects, the first subnetwork comprises a first set of weights, and the second subnetwork comprises the first set of weights and a second set of weights.

In some aspects, training the second subnetwork comprises refining only the second set of weights.

In some aspects, the method 700 further includes partitioning clients in a federated learning system into a plurality of sets of clients based on the plurality of sets of training exemplars, transmitting the first subnetwork to a first client in a first set of the plurality of sets of clients, and transmitting the second subnetwork to a second client in a second set of the plurality of sets of clients.

In some aspects, the method 700 further includes receiving, from each respective client in the federated learning system, a respective set of weight updates for a respective subnetwork and a respective set of hyperparameter gradients, aggregating the sets of weight updates, and aggregating the sets of hyperparameter gradients.

In some aspects, during training, the second subnetwork is not transmitted to the first client.

In some aspects, the approximated marginal likelihood is defined as

$${\sum }_{i = 1}^{C} log {𝔼}_{w \sim q ( w \vert {𝒟}_{1 : i - 1} )} [ p ( {𝒟}_{i} \vert w ) ] ,$$

wherein: C is a number of the plurality of sets of training exemplars, [symbol] ᵢ is an i-th set of training exemplars, from the plurality of sets of training exemplars, [symbol] _{1:j} is an aggregate of sets of training exemplars from [symbol] ₁ through [symbol] ⱼ, w is parameters of the neural network, q(w| [symbol] _{1:i-1}) is an approximate posterior distribution over the parameters w conditioned on sets of training exemplars [symbol] _{1:i-1}, [symbol] _{w˜q(w)} is an expectation with respect to samples of parameters w drawn from a probability distribution q(w), and p( [symbol] ᵢ|w) is a probability of exemplars in a set of training exemplars [symbol] ᵢ, given the parameters are w.

In some aspects, the plurality of subnetworks comprises C subnetworks, and the approximate posterior distribution q(w| [symbol] _{1:i-1}) comprises a point-estimate of the parameters w obtained by training a subnetwork on a set of training exemplars [symbol] _{1:i-1}.

In some aspects, the method 700 further includes accessing input data for runtime inferencing; and generating an output inference by processing the input data using the neural network.

### Example Processing System for Hyperparameter Optimization Using Partitioned Machine Learning Models

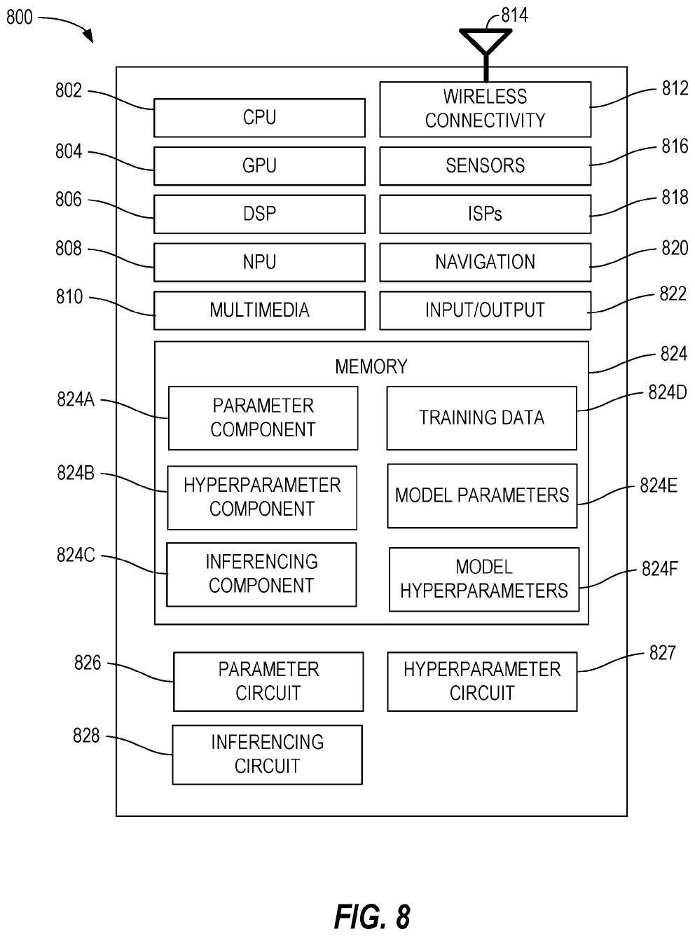

In some aspects, the workflows, techniques, and methods described with reference to FIGS. 1-7 may be implemented on one or more devices or systems. FIG. 8 depicts an example processing system 800 configured to perform various aspects of the present disclosure, including, for example, the techniques and methods described with respect to FIGS. 1-7. In one aspect, the processing system 800 may correspond to a training component, such as training component 120 of FIGS. 1, 2A, 2B, and/or 2C. Although depicted as a single system for conceptual clarity, in at least some aspects, as discussed above, the operations described below with respect to the processing system 800 may be distributed across any number of devices.

Processing system 800 includes a central processing unit (CPU) 802, which in some examples may be a multi-core CPU. Instructions executed at the CPU 802 may be loaded, for example, from a program memory associated with the CPU 802 or may be loaded from a partition of memory 824.

Processing system 800 also includes additional processing components tailored to specific functions, such as a graphics processing unit (GPU) 804, a digital signal processor (DSP) 806, a neural processing unit (NPU) 808, a multimedia processing unit 810, and a wireless connectivity component 812.

An NPU, such as 808, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In one implementation, NPU 808 is a part of one or more of CPU 802, GPU 804, and/or DSP 806.

In some examples, wireless connectivity component 812 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 812 is further connected to one or more antennas 814.

Processing system 800 may also include one or more sensor processing units 816 associated with any manner of sensor, one or more image signal processors (ISPs) 818 associated with any manner of image sensor, and/or a navigation component 820, which may include satellite-based positioning system components (e.g., GPS or GLONASS) as well as inertial positioning system components.

Processing system 800 may also include one or more input and/or output devices 822, such as screens, touch-sensitive surfaces (including touch-sensitive displays), physical buttons, speakers, microphones, and the like.

In some examples, one or more of the processors of processing system 800 may be based on an ARM or RISC-V instruction set.

Processing system 800 also includes memory 824, which is representative of one or more static and/or dynamic memories, such as a dynamic random access memory, a flash-based static memory, and the like. In this example, memory 824 includes computer-executable components, which may be executed by one or more of the aforementioned processors of processing system 800.

In particular, in this example, memory 824 includes a parameter component 824A, a hyperparameter component 824B, and an inferencing component 824C. Though depicted as discrete components for conceptual clarity in FIG. 8, the illustrated components (and others not depicted) may be collectively or individually implemented in various aspects.

In the illustrated example, the memory 824 further includes training data 824D, model parameters 824E, and model hyperparameters 824F. The training data 824D may generally correspond to a set of training exemplars used to train or refine a machine learning model (e.g., training data 115 of FIG. 1), as discussed above. The model parameters 824E may generally correspond to the learnable or trainable parameters of one or more machine learning models, as discussed above. For example, in the case of a neural network, the model parameters 824E may include edge weights. In some aspects, as discussed above, the model parameters 824E may be partitioned into a set of partitions or subsets. The model hyperparameters 824F may generally correspond to one or more variables used to control or guide the training process, such as the learning rate, of the machine learning model.

Though depicted as residing in memory 824 for conceptual clarity, in some aspects, some or all of the training data 824D, model parameters 824E, and hyperparameters 824F may reside in any other suitable location. For example, in the case of a federated learning approach, the training data 824D may be maintained locally by participating clients.

Processing system 800 further comprises parameter circuit 826, hyperparameter circuit 827, and inferencing circuit 828. The depicted circuits, and others not depicted, may be configured to perform various aspects of the techniques described herein.

For example, parameter component 824A and parameter circuit 826 may be used to update model parameters 824E within each model partition based on a corresponding set of training data 824D, as discussed above. Hyperparameter component 824B and hyperparameter circuit 827 may be used to generate approximated marginal likelihoods using the training data 824D and model partitions, as well as to update the model hyperparameters 824F based on the approximated marginal likelihood, as discussed above. The inferencing component 824C and inferencing circuit 828 may be used to perform runtime inferencing using the trained model parameters 824E for the entire model, as discussed above.

Though depicted as separate components and circuits for clarity in FIG. 8, parameter circuit 826, hyperparameter circuit 827, and inferencing circuit 828 may collectively or individually be implemented in other processing devices of processing system 800, such as within CPU 802, GPU 804, DSP 806, NPU 808, and the like.

Generally, processing system 800 and/or components thereof may be configured to perform the methods described herein.

Notably, in other aspects, aspects of processing system 800 may be omitted, such as where processing system 800 is a server computer or the like. For example, multimedia processing unit 810, wireless connectivity component 812, sensor processing units 816, ISPs 818, and/or navigation component 820 may be omitted in other aspects. Further, aspects of processing system 800 maybe distributed between multiple devices.

### EXAMPLE CLAUSES

Implementation examples are described in the following numbered clauses:

Clause 1: A method comprising: determining a plurality of subnetworks, of a neural network; facilitating training of a first subnetwork of the plurality of subnetworks using a first set of training exemplars from a plurality of sets of training exemplars; facilitating training of a second subnetwork of the plurality of subnetworks using a second set of training exemplars from the plurality of sets of training exemplars; generating an approximated marginal likelihood for the neural network based at least in part on a first loss generated by processing the second set of training exemplars using the first subnetwork; and refining one or more hyperparameters of the neural network based on the approximated marginal likelihood.

Clause 2: A method according to Clause 1, wherein determining the plurality of subnetworks comprises partitioning parameters of the neural network based on defined grouping criteria.

Clause 3: A method according to Clause 1 or 2, further comprising partitioning a corpus of training exemplars into the plurality of sets of training exemplars.

Clause 4: A method according to any of Clauses 1-3, further comprising: facilitating training of a third subnetwork of the plurality of subnetworks using a third set of training exemplars from the plurality of sets of training exemplars; and generating the approximated marginal likelihood for the neural network based further on summing the first loss and a second loss generated by processing the third set of training exemplars using the second subnetwork.

Clause 5: A method according to any of Clauses 1-4, wherein: the first subnetwork comprises a first set of weights, and the second subnetwork comprises the first set of weights and a second set of weights.

Clause 6: A method according to any of Clauses 5, wherein training the second subnetwork comprises refining only the second set of weights.

Clause 7: A method according to any of Clauses 1-6, further comprising: partitioning clients in a federated learning system into a plurality of sets of clients based on the plurality of sets of training exemplars; transmitting the first subnetwork to a first client in a first set of the plurality of sets of clients; and transmitting the second subnetwork to a second client in a second set of the plurality of sets of clients.

Clause 8: A method according to any of Clauses 1-7, further comprising: receiving, from each respective client in the federated learning system, a respective set of weight updates for a respective subnetwork and a respective set of hyperparameter gradients; aggregating the sets of weight updates; and aggregating the sets of hyperparameter gradients.

Clause 9: A method according to any of Clauses 1-8, wherein, during training, the second subnetwork is not transmitted to the first client.

Clause 10: A method according to any of Clauses 1-9, wherein the approximated marginal likelihood is defined as

$${\sum }_{i = 1}^{C} log {𝔼}_{w \sim q ( w \vert {𝒟}_{1 : i - 1} )} [ p ( {𝒟}_{i} \vert w ) ] ,$$

wherein: C is a number of the plurality of sets of training exemplars, [symbol] ᵢ is an i-th set of training exemplars, from the plurality of sets of training exemplars, [symbol] _{1:j} is an aggregate of sets of training exemplars from [symbol] ₁ through [symbol] ⱼ, w is parameters of the neural network, q(w| [symbol] _{1:i-1}) is an approximate posterior distribution over the parameters w conditioned on sets of training exemplars [symbol] _{1:i-1}, [symbol] _{w˜q(w)} is an expectation with respect to samples of parameters w drawn from a probability distribution q(w), and p( [symbol] ᵢ|w) is a probability of exemplars in a set of training exemplars [symbol] ᵢ, given the parameters are w.

Clause 11: A method according to any of Clauses 1-10, wherein: the plurality of subnetworks comprises C subnetworks, and the approximate posterior distribution q(w| [symbol] _{1:i-1}) comprises a point-estimate of the parameters w obtained by training a subnetwork on a set of training exemplars [symbol] _{1:i-1}.

Clause 12: A method according to any of Clauses 1-11, further comprising: accessing input data for runtime inferencing; and generating an output inference by processing the input data using the neural network.

Clause 13: A processing system comprising: a memory comprising computer-executable instructions; and one or more processors configured to execute the computer-executable instructions and cause the processing system to perform a method in accordance with any of Clauses 1-12.

Clause 14: A processing system comprising means for performing a method in accordance with any of Clauses 1-12.

Clause 15: A non-transitory computer-readable medium comprising computer-executable instructions that, when executed by one or more processors of a processing system, cause the processing system to perform a method in accordance with any of Clauses 1-12.

Clause 16: A computer program product embodied on a computer-readable storage medium comprising code for performing a method in accordance with any of Clauses 1-12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method, comprising:
determining a plurality of subnetworks, of a neural network;
facilitating training of a first subnetwork of the plurality of subnetworks using a first set of training exemplars from a plurality of sets of training exemplars;
facilitating training of a second subnetwork of the plurality of subnetworks using a second set of training exemplars from the plurality of sets of training exemplars;
generating an approximated marginal likelihood for the neural network based at least in part on a first loss generated by processing the second set of training exemplars using the first subnetwork; and
refining one or more hyperparameters of the neural network based on the approximated marginal likelihood.

2. The computer-implemented method of claim 1, wherein determining the plurality of subnetworks comprises partitioning parameters of the neural network based on defined grouping criteria.

3. The computer-implemented method of claim 1, further comprising partitioning a corpus of training exemplars into the plurality of sets of training exemplars.

4. The computer-implemented method of claim 1, further comprising:
facilitating training of a third subnetwork of the plurality of subnetworks using a third set of training exemplars from the plurality of sets of training exemplars; and
generating the approximated marginal likelihood for the neural network based further on summing the first loss and a second loss generated by processing the third set of training exemplars using the second subnetwork.

5. The computer-implemented method of claim 1, wherein:
the first subnetwork comprises a first set of weights, and
the second subnetwork comprises the first set of weights and a second set of weights.

6. The computer-implemented method of claim 5, wherein training the second subnetwork comprises refining only the second set of weights.

7. The computer-implemented method of claim 1, further comprising:
partitioning clients in a federated learning system into a plurality of sets of clients based on the plurality of sets of training exemplars;
transmitting the first subnetwork to a first client in a first set of the plurality of sets of clients; and
transmitting the second subnetwork to a second client in a second set of the plurality of sets of clients.

8. The computer-implemented method of claim 7, further comprising:
receiving, from each respective client in the federated learning system, a respective set of weight updates for a respective subnetwork and a respective set of hyperparameter gradients;
aggregating the sets of weight updates; and
aggregating the sets of hyperparameter gradients.

9. (canceled)

10. (canceled)

11. (canceled)

12. (canceled)

13. A processing system comprising:
a memory comprising computer-executable instructions; and
one or more processors configured to execute the computer-executable instructions and cause the processing system to perform an operation comprising:
determining a plurality of subnetworks, of a neural network;
facilitating training of a first subnetwork of the plurality of subnetworks using a first set of training exemplars from a plurality of sets of training exemplars;
facilitating training of a second subnetwork of the plurality of subnetworks using a second set of training exemplars from the plurality of sets of training exemplars;
generating an approximated marginal likelihood for the neural network based at least in part on a first loss generated by processing the second set of training exemplars using the first subnetwork; and
refining one or more hyperparameters of the neural network based on the approximated marginal likelihood.

14. The processing system of claim 13, wherein determining the plurality of subnetworks comprises partitioning parameters of the neural network based on defined grouping criteria.

15. The processing system of claim 13, the operation further comprising partitioning a corpus of training exemplars into the plurality of sets of training exemplars.

16. The processing system of claim 13, the operation further comprising:
facilitating training of a third subnetwork of the plurality of subnetworks using a third set of training exemplars from the plurality of sets of training exemplars; and
generating the approximated marginal likelihood for the neural network based further on summing the first loss and a second loss generated by processing the third set of training exemplars using the second subnetwork.

17. The processing system of claim 13, wherein:
the first subnetwork comprises a first set of weights, and
the second subnetwork comprises the first set of weights and a second set of weights.

18. The processing system of claim 17, wherein training the second subnetwork comprises refining only the second set of weights.

19. The processing system of claim 13, the operation further comprising:
partitioning clients in a federated learning system into a plurality of sets of clients based on the plurality of sets of training exemplars;
transmitting the first subnetwork to a first client in a first set of the plurality of sets of clients; and
transmitting the second subnetwork to a second client in a second set of the plurality of sets of clients.

20. The processing system of claim 19, the operation further comprising:
receiving, from each respective client in the federated learning system, a respective set of weight updates for a respective subnetwork and a respective set of hyperparameter gradients;
aggregating the sets of weight updates; and
aggregating the sets of hyperparameter gradients.

21. The processing system of claim 19, wherein, during training, the second subnetwork is not transmitted to the first client.

22. The processing system of claim 13, wherein the approximated marginal likelihood is defined as
$${\sum }_{i = 1}^{C} log {𝔼}_{w \sim q ( w \vert {𝒟}_{1 : i - 1} )} [ p ( {𝒟}_{i} \vert w ) ] ,$$
wherein:
C is a number of the plurality of sets of training exemplars, [symbol]
ᵢ is an i-th set of training exemplars, from the plurality of sets of training exemplars, [symbol]
_{1:j} is an aggregate of sets of training exemplars from [symbol] ₁ through [symbol] ⱼ,
w is parameters of the neural network,
q(w| [symbol] _{1:i-1}) is an approximate posterior distribution over the parameters w conditioned on sets of training exemplars [symbol] _{1:i-1}, [symbol]
_{w˜q(w)} is an expectation with respect to samples of parameters w drawn from a probability distribution q(w), and
p( [symbol] ᵢ|w) is a probability of the exemplars in a set of training exemplars [symbol] ᵢ, given the parameters are w.

23. The processing system of claim 22, wherein:
the plurality of subnetworks comprises C subnetworks, and
the approximate posterior distribution q(w| [symbol] _{1:i-1}) comprises a point-estimate of the parameters w obtained by training a subnetwork on a set of training exemplars [symbol] _{1:i-1}.

24. The processing system of claim 13, further comprising:
accessing input data for runtime inferencing; and
generating an output inference by processing the input data using the neural network.

25.-30. (canceled)
